(19) United States
(12) Patent Application Publication
(10) Pub. No.: US 2003/0043044 A1
(43) Pub. Date: Mar. 6, 2003

(54) Advanced warning system for the physically challenged

(76) Inventor: Bill Hunter, Crawfordville, FL (US)

Correspondence Address: Carnes, Cona & Dixon, Innovation Park, 1673 West Paul Dirac Drive, Tallahassee, FL, 32310-3763, US

(21) Appl. No.: 10/233,891

(22) Filed: Sep. 3, 2002

Related U.S. Application Data
(60) Provisional application No. 60/316,621, filed on Sep. 4, 2001.

(51) Int. Cl. G08B 23/00

(52) U.S. Cl. 340/573.4; 340/539

(57) ABSTRACT

An advanced warning system for the physically challenged, which includes a first device disposed in the vicinity of a hazard for the physically challenged and including a transmitter and an antenna disposed for transmitting radio signals warning of the presence of the hazard. The system further includes a second device located with or on the physically challenged and including a receiver adapted for receiving the warning signal from the first device and including structure for indicating to the physically challenged user that a hazard is nearby. The system may be configured to include a plurality of the first devices distributed throughout an area having an equal plurality of potential hazards. In such configuration, the system may include a central radio station adapted for sending control update signals to each of the first devices.

### BACKGROUND OF THE INVENTION

1. Field of the Invention

The present invention relates generally to an advanced warning system for the physically challenged and more particularly to a system of warning devices for installation within any type facility that will alert the physically challenged of potentially life threatening and safety hazards within their immediate surrounding area by a visual, and/or tactile, and/or audible signal, for adequately and efficiently alerting the physically challenged person of the imminent hazards.

2. Description of the Prior Art

A person who is rendered disabled due to a physical disability is not handicapped by their physical disability, but by a world that has failed to meet the needs of these people who strive to achieve independent living. To this end, in 1968, the United States of America passed the Architectural Barriers Act (ABA) and then in 1990 the Americans with Disabilities Act (ADA) in order to achieve independent living for the disabled. As a direct result of the above mentioned Acts, a growing number of disabled people are in the workplace, public businesses and educational facilities.

In order for the disabled to achieve independent living, they require access to everywhere the unimpaired have access, such as: transportation, lodging, public stores, state and federal building and educational facilities. It is seen that everyday movement through these areas for the physically challenged can be difficult and hazardous, sometimes even impossible. In buildings designed prior to the Architectural Barriers Act (ABA) and Americans with Disabilities Act (ADA), the pitfalls can be numerous. New buildings must be constructed in compliance with the Americans with Disabilities Act (ADA), however there are still many areas that are potential life threatening and safety hazards. For example, stairs in open public areas, sunken common areas or step-downs of any kind, as well as temporary situation such as raised sidewalks, inoperative equipment, water leaks, open ditches and construction/repair sites, all of which pose a hazard to the disabled.

It is seen in the prior art that there are many warning systems, particularly for use in a vehicle for alerting the driver of hazardous conditions. For example, in U.S. Pat. No. 6,081,188 issued to Kutlucinar et al wherein disclosed is a vehicular hazard warning system which provides for an apparatus and method to warn drivers of a hazardous condition experienced by another driver.

Yet another example is seen in U.S. Pat. No. 6,020,815 issued to Eslambolchi et al wherein disclosed is a utility right-of-way safety monitor that provides for a vibration or audible tone to alert workers in the vicinity of a transportation path of the presence of an oncoming vehicle. A detector/transmitter assembly broadcasts an RF signal to each workers individual receiver, thereby alerting the worker of the approaching vehicle.

Another example is seen in U.S. Pat. No. 6,215,410 issued to Singer et al wherein disclosed is a rescue guiding system for underground mining personnel. This system provides for the guidance of work personnel from a life threatening work area through a passageway to a refuge bay. This system utilizes a network of short-range radio transmitters which transmit different coded signals to the worker carrying the receiver, thereby guiding the worker in the direction of safety.

None of these previous efforts, however provide the benefits intended with the present invention, such as providing a system which will successfully warn those physically challenged of potential life threatening and safety hazards in their surrounding area and which will accomplish the warning by a simplified unit with either an audible signal, or used in combination with tactile and visual signals. What is needed is a system, which will activate a warning means through a series of receivers by means of a signal from a series of devices strategically placed in potentially life threatening and safety hazard areas. Thus, the physically challenged person will carry the receiver and will receive a warning signal if they approach within a predetermined range of a potentially life threatening or safety hazard area. The present invention addresses and solves the above aforementioned problems by providing a means and a method for the physically challenged to be alerted to potentially hazardous areas and avoid them.

Additionally, prior techniques do not suggest the present inventive combination of component elements as disclosed and claimed herein. The present invention achieves its intended purposes, objectives and advantages over the prior art devices through a new, useful and unobvious combination of component elements, which is simple to use, with the utilization of a minimum number of functioning parts, at a reasonable cost to manufacture, assemble, test and by employing only readily available material.

### SUMMARY OF THE INVENTION

The present invention provides for a novel and unique system which will transmit a warning means upon the approach of a physically challenged person carrying a receiver device, so as to alert the person of a potential life threatening or safety hazard in their immediate area. This warning means will be activated early enough to allow the physically challenged person to avoid the potentially dangerous situation, such as a temporarily raised sidewalk. This system of the present invention is used in combination with a single or plurality of transmitters. The system of the present invention is successful at alerting the appropriate disabled individuals and is unique and novel in design.

This system of the present invention comprises a first device and a second device. The first device may be secured atop a portable device, such as a warning sign or temporary barriers, or may be permanently affixed in selected areas. The first device of the present invention is a compact and portable warning node unit which is comprised of a warning lamp, transmitter, receiver, control circuitry, antenna and a DC and AC power supply.

The second device of the present invention is a receiver which may be worn on the wrist, belt or pocket of the user, or simply attached to a wheelchair, or the like for convenience. The receiver of the present invention may be secured to the user or wheelchair by either a clip for easy attachment to a belt or pocket or by means of a strap, with Velcro or the like for quick and simple attachment. The receiver is comprised of a securing means, an on/off button specifically designed for ease of use by a physically challenged person, an activity light, a power indicator light and a speaker.

The object of the first device is to send a signal at a range of approximately ten feet or more. The object of the second device is to receive a signal if placed within the transmitter signal range of the first device. Upon receipt of a transmitter signal, activation of a warning signal in the second device (receiver) occurs. This will alert the physically challenged individual of the impending life threatening or safety hazard situation. Thereby, allowing enough time to adequately determine a safer course.

Accordingly, it is the object of the present invention to provide for an advanced warning system for the physically challenged which will overcome the deficiencies, shortcomings, and drawbacks of prior art and methods thereof.

Another object of the present invention is to provide an advanced warning system for the physically challenged which will decrease business and facility liability and make businesses and facilities more compliant with the Americans With Disabilities Act and regulations thereof.

Yet another object of the present invention is to provide a means for improved and safer independent living conditions for the physically challenged, as well as decreasing the need for personnel/staff to assist the physically challenged when moving in predetermined hazardous areas.

Still another object of the present invention, to be specifically enumerated herein, is to provide for an advanced warning system for the physically challenged in accordance with the preceding objects and which will conform to conventional forms of manufacture, be of simple construction and easy to use so as to provide a system that would be economically feasible, long lasting and relatively trouble free in operation.

Although there have been other inventions related to warning signals, none of the inventions have resolved safety concerns for the physically challenged, become sufficiently compact, low cost, and reliable enough to become commonly used. The present invention meets the requirements of the simplified design, compact size, low initial cost, low operating cost, ease of installation and maintainability, and minimal amount of training to successfully employ the invention.

The foregoing has outlined some of the more pertinent objects of the invention. These objects should be construed to be merely illustrative of some of the more prominent features and application of the intended invention. Many other beneficial results can be obtained by applying the disclosed invention in a different manner or modifying the invention within the scope of the invention defined by the claims taken in conjunction with the accompanying drawings.

### BRIEF DESCRIPTION OF THE DRAWINGS

FIG. 1 is a perspective view of the warning node of the present invention.

FIG. 2 is a view of a receiver with a clip type attachment to be worn on the users belt or pocket.

FIG. 3 is a top planar view of a receiver of the present invention which illustrates the adjustable wrist strap attachment.

FIG. 4 is an example of the warning node of the present invention as secured to a temporary or portable warning device.

FIG. 5 is a depiction of the warning node as installed within a facility, displaying a wheelchair prior to encountering a potential hazard.

FIG. 6 is a diagram displaying a facility manager's monitoring panel illustrating the status of various nodes either temporarily or permanently installed throughout a facility.

FIG. 7 is a perspective view of an alternative embodiment of the warning node device of the present invention.

FIG. 8 is a cross sectional view of the warning node of the alternative embodiment illustrating the various components.

Similar reference numerals refer to similar parts throughout the views of the drawings.

### PREFERRED EMBODIMENT OF THE PRESENT INVENTION

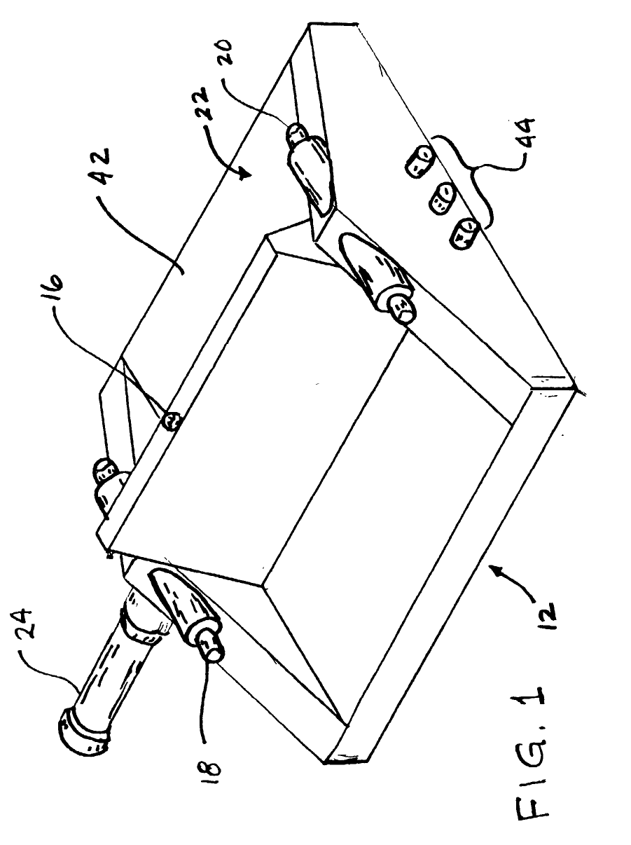

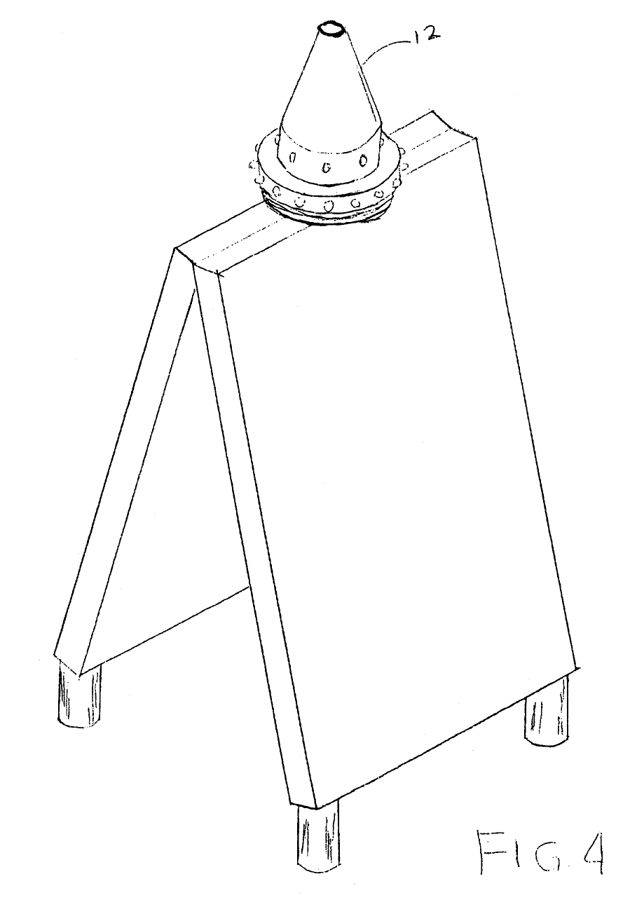

The present invention is an advanced warning system for the physically challenged designed and configured for installation within any type facility that will alert the physically challenged of potentially life threatening and safety hazards within their immediate surrounding area by an individual visual signal, or in combination with tactile and audible signals. With reference to the drawings and in particular to FIGS. 1-7, there is shown the present invention, known as an advanced warning system for the physically challenged. This particular system of warning devices is designed to be installed within any type facility, specifically atop a portable device, such as a warning sign or temporary barrier, or may be permanently affixed in selected areas. This will provide for a device that is compact and aesthetically pleasing, yet quick and easy to install, while still allowing for a completely portable device, as well as a device which may be permanently installed within a facility.

As seen in these figures, the present invention is an advanced warning system for the physically challenged having a first device and a second device. The first device, the warning node 12 (FIG. 1) is designed to be secured atop a portable device, such as a warning sign or temporary barriers, or may be permanently affixed in selected areas. The first device 12 is a compact and portable warning nod unit, comprised of a warning lamp 16, an infrared line of sight transmitter 18, an infrared diode receiver 20, control circuitry 22, AM loop antenna 24 and a DC and AC power supply 26.

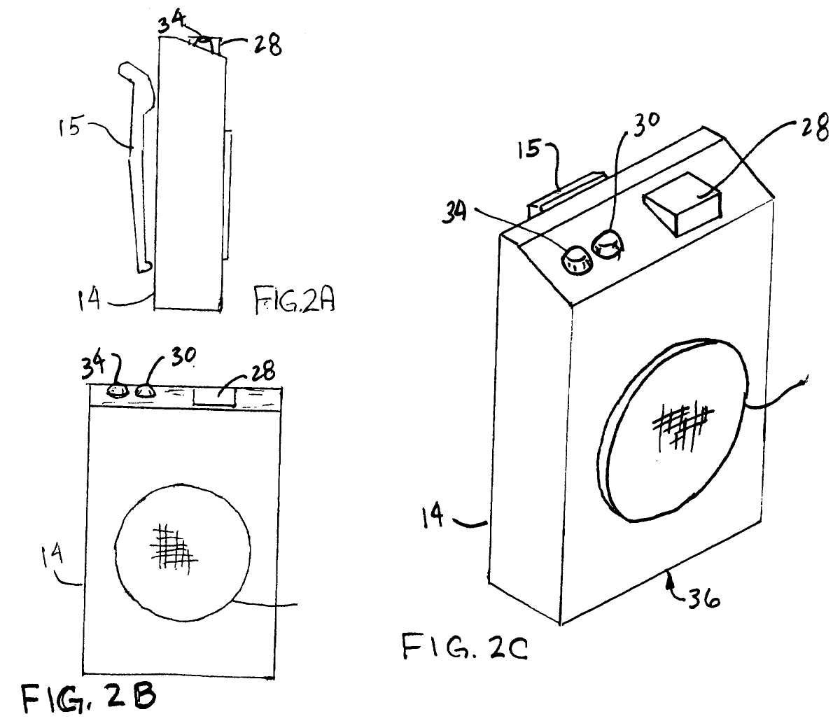

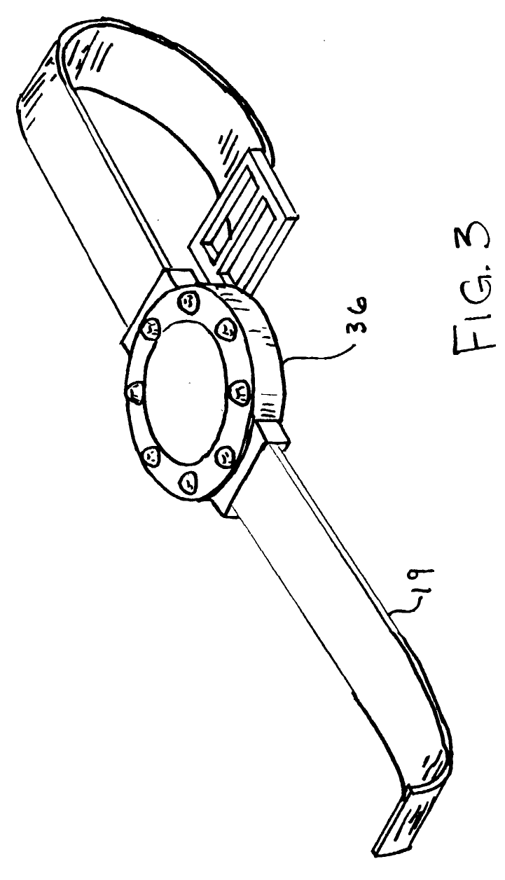

The second device of the present invention (FIGS. 2A, 2B and 2C) is a receiver 14 which may be worn on the wrist, belt or pocket of the user, or attached to a wheelchair or the like by means of a clip 15 as illustrated in FIG. 2A or a strap 19 as illustrated in FIG. 3. The receiver of the present invention is specifically designed for ease of use by a physically challenged person and is comprised of an on/off power button 28, a speaker 29, an activity indicator light 30, a power indicator and a speaker button 34. In order to enhance ease of use of the personal receiver 14 by the physically challenged person, the personal receiver 14 allows the user to customize the type of alarm signal given, either audible, tactile, visual or any combination thereof.

In an alternative embodiment, the personal receiver 14 may include a transmitter for sending a “wake-up” call to the first device 12. Moreover, this transmitter may be utilized to adjust the operating range of the warning node 12. The customization of the personal receiver 14 allows the user to tailor the system of the present invention to meet their individual needs and then quickly and easily reset for other users to customize. The personal receiver will control the type of alarm given, for example, an audible, tactile or visible alarm, or any combination thereof. The personal receiver will also control the operating range of the warning node device 12.

FIG. 1 is an illustration of the warning node device 12 of the present invention. As shown, the warning node is compact and unobtrusive, as well as aesthetically pleasing. Located directly in the middle of the warning node 12, extending upward to be easily seen is the warning lamp 16. On the backside of the warning node 12 is the diode transmitter 18. On the front side are the diode receivers 20. Extending outward from the body of the warning node 12, directly behind the transmitter 18 is an AM loop antenna 24. On the opposite side, on the front of the warning node 12 is a status indicator 44. In addition, located directly behind the warning lamp is the battery and circuitry housing 42.

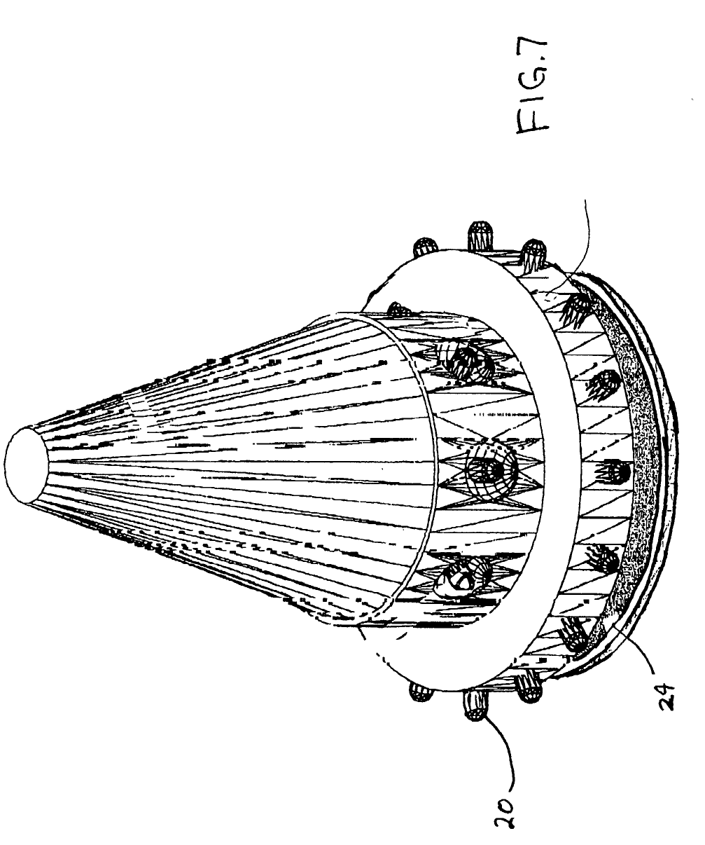

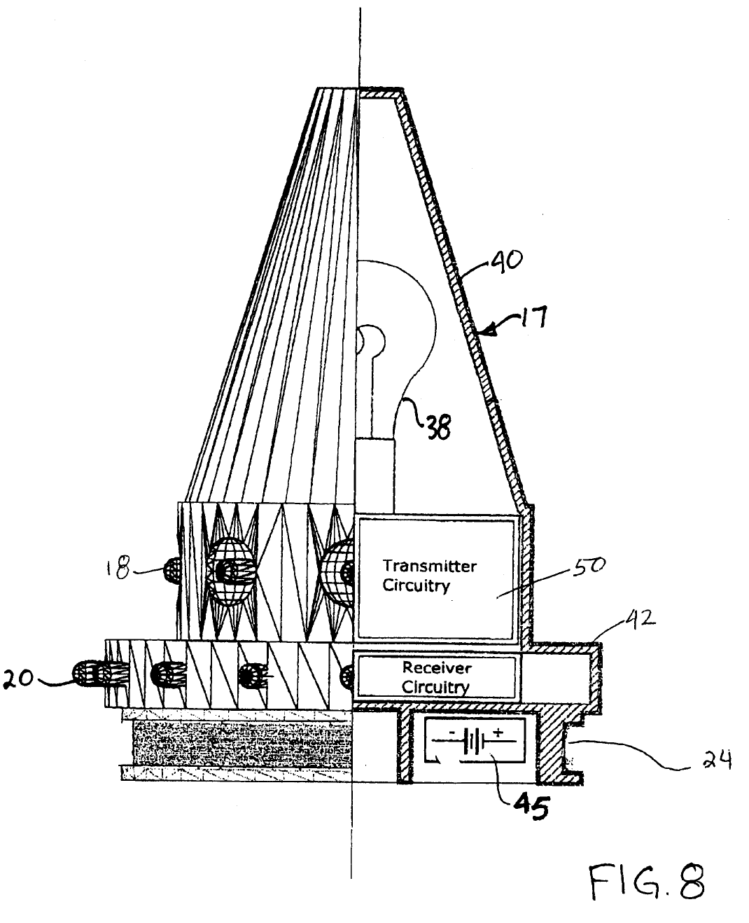

Illustrated in FIG. 7 is an alternative embodiment of the warning node device of the present invention. Located at the top of the warning node device, directly above the battery and transmitter housing is a warning lamp 17. The warning lamp 17 is designed so as to provide either a flashing or continuous illumination of light activated by an incoming signal to the receiver 14, thereby indicating that a physically challenged person carrying a receiver device has come within a predetermined range from a potentially life threatening or hazardous area. In this alternative embodiment, to further enhance the physically challenged person, the predetermined range of receiving a signal alerting the user of a potential hazard may be modified and reset by the user. The warning lamp 16 is powered by battery or the like. In the preferred embodiment, the warning lamp 16 is powered by a DC power supply, an individual battery that is rechargeable and detachable from an AC-DC power converter. The warning lamp is comprised of a lamp/light source 38 located on the interior of the warning lamp, with a lamp lens 40 covering the entire portion of the warning lamp, as illustrated in FIG. 8.

In the alternative embodiment, below the warning lamp is the transmitter circuitry. This area designated for the transmitter circuitry contains the battery and transmitter housing 42. Affixed to the battery and transmitter housing 42 are a series of line of sight transmitters 18 arrayed in a polar configuation around the body of the battery and transmitter housing 42. A series of eight infrared LED type line of sight transmitters are arrayed in a polar fashion and the LED's maybe of different colors. This array of LED's may be arranged in order to respond to various signals from the transmitter. The purpose of the transmitters is to establish directional vectors for incoming receivers by emitting a different frequency when in use. This device of may work in a suspended mode that would be alerted by a motion sensor or an incoming receiver with emitting capabilities. An incoming signal to the warning node would be received an interpreted by the receiver circuitry, which provides for the receiver housing. Affixed to the receiver housing are a series of infrared diode receivers 20 designed and configured to receive incoming signals. In the alternative embodiment, the warning node will operate in either an active or standby mode in order to conserve power. The node may be remotely switched from standby to active whenever a personal receiver comes within operating range, while returning to standby at a predetermined time interval once the personal receiver is out of the signal range.

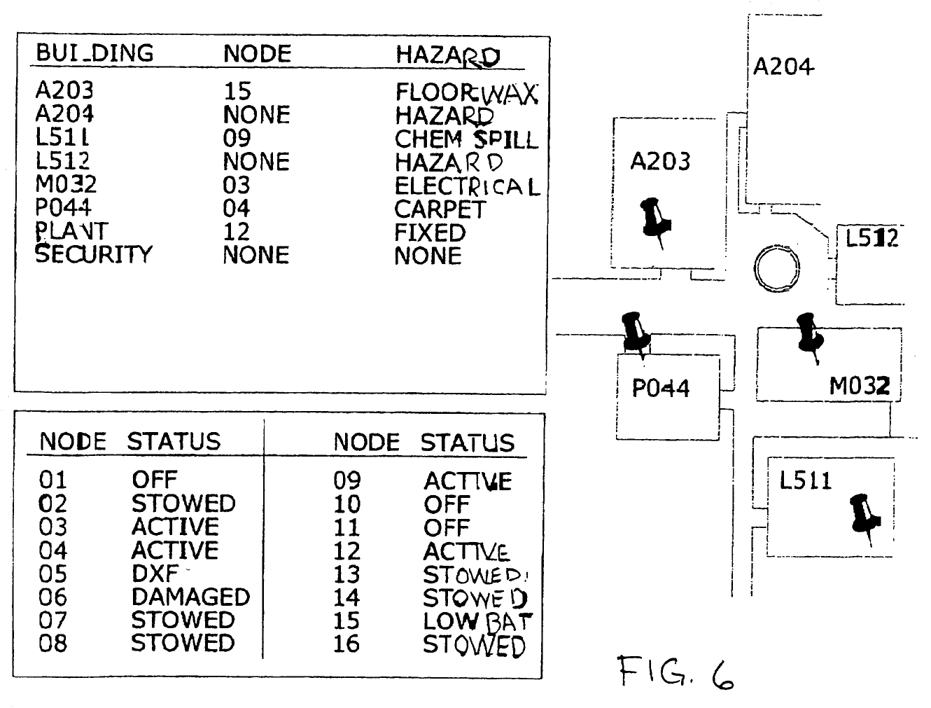

In order to maintain performance status of warning nodes, either displaced within a facility or elsewhere, the warning node device of the present invention provides for an AM loop antenna 24 which serves to transmit the nodes performance status to a facilities director's monitoring panel. This will allow a facility to have complete monitoring capabilities of all warning nodes displaced within the facility, thus preventing unnecessary accidents and reducing facility liability. Located interior to the AM loop antenna 24 is a housing area for batteries 45. FIG. 6 is a diagram displaying a facilities manager's monitoring panel illustrating the status of various nodes installed throughout the facility, thus providing continuous monitoring capabilities.

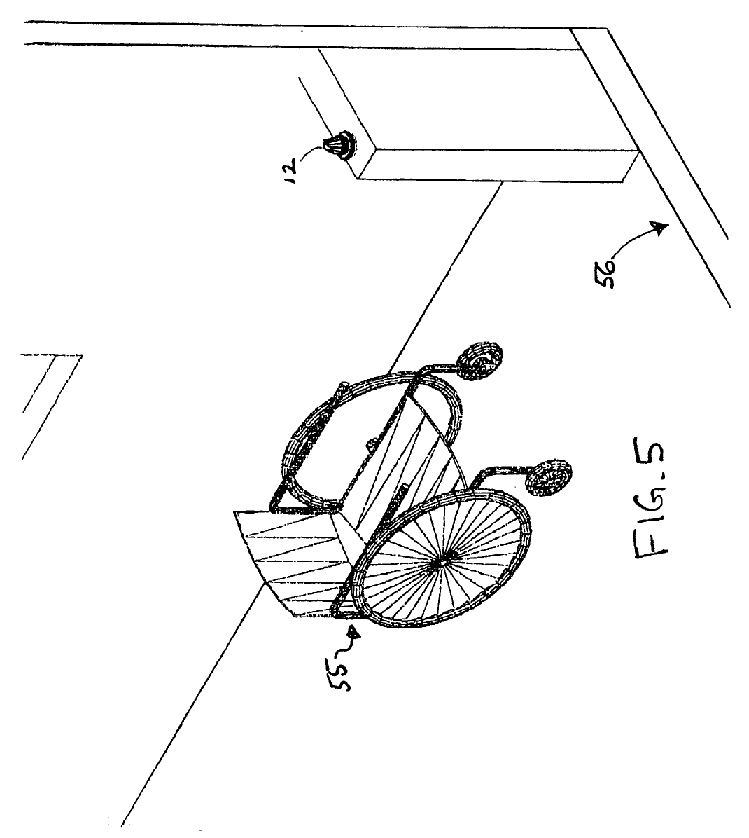

The warning node device of the present invention may be mounted atop a portable device, such as warning signage or temporary barriers, or permanently affixed in selected areas, such as a facility. For temporary or permanent installation of the warning node device, the warning node provides for a mounting bracket or the like, which allows for quick and easy attachment and removal of the device to any desired location. FIG. 5 is a depiction of a facility equipped with the warning system of the present invention. As shown in this diagram, a wheelchair 55 is equipped with the personal receiver 14 (not shown in FIG. 5) and the warning node 12 is permanently affixed near a hazard 56, which a change in floor elevation.

While the invention has been particularly shown and described with reference to an embodiment thereof, it will be understood by those skilled in the art that various changes in form and detail may be made without departing from the spirit and scope of the invention.

I claim:

1. An advanced warning system for the physically challenged, said system comprising:
a) a first device disposed in the vicinity of a hazard for the physically challenged and including a transmitter and an antenna disposed for transmitting radio signals warning of the presence of said hazard; and,
b) a second device located with the physically challenged and including a receiver adapted for receiving said warning signal from said first device and including structure for indicating to the physically challenged user that a hazard is nearby.

2. The system as in claim 1 wherein said first device includes a source of electrical power, thereby making said first device mobile.

3. The system as in claim 1 wherein said second device includes a source of electrical power, thereby making said second device mobile.

4. The system as in claim 1 wherein said second device includes a strap for affixing it to the wrist of the physically challenged user.

5. The system as in claim 1 wherein said structure includes an audible alarm.

6. The system as in claim 1 wherein said structure includes a vibrator.

7. The system as in claim 1 wherein said structure includes an indicator lamp.

8. The system as in claim 1 wherein said antenna is an AM loop antenna.

9. The system as in claim 1 wherein said second device includes a clip for affixing it to clothing worn by the physically challenged user.

10. The system as in claim 1 wherein said second device includes a transmitter for sending signals to said first device.

11. The system as in claim 1 wherein said first device includes a receiver for receiving signals from said second device.

12. An advanced warning system for the physically challenged, said system comprising:
a) a plurality of transmitter devices each being disposed adjacent to a potential hazard for the physically challenged and each of said transmitter devices including an antenna for directing signals warning of the presence of said potential hazard; and,
b) a receiver device located with the physically challenged user and being adapted for receiving said warning signal from any one of said transmitter devices for indicating to the physically challenged user that a potential hazard is nearby.

13. The system as in claim 12 wherein each of said transmitter devices include a receiver adapted for receiving signals from said receiver device.

14. The system as in claim 12 wherein said receiver device includes a transmitter for sending signals to said first device.

15. The system as in claim 12 further including a central radio station disposed for sending control and update signals to each of said transmitting devices.

16. The system as in claim 12 wherein each of said transmitter devices sending status signals to a central radio station.

17. A system for warning the physically challenged of potential hazards, said system comprising:
a) a plurality of first devices each being disposed in the vicinity of each of said hazards and including a transmitter and an antenna disposed for directing radio signals warning of the presence of a hazard, and including a receiver;
b) a second device located with the physically handicapped and including a receiver adapted for receiving said warning signal from said first device and including structure for indicating to the physically challenged user that said a is nearby; and,
c) a central radio station adapted for transmitting control and update signals to each of said first devices.

18. The system as in claim 17 wherein said structure includes an audible alarm.

19. The system as in claim 17 wherein said structure includes a vibrator.

20. The system as in claim 17 wherein said structure includes an indicator lamp.
